(19) United States
(12) Patent Application Publication
(10) Pub. No.: US 2019/0084854 A1
(43) Pub. Date: Mar. 21, 2019

(54) PROCESSES FOR TREATMENT OF SPENT ALKALINE WASTE STREAMS

(71) Applicant: UOP LLC, Des Plaines, IL (US)

(72) Inventors: F. Stephen Lupton, Evanston, IL (US); Bipin R. Ranade, Brookfield, IL (US); William G. Sheridan, Naperville, IL (US)

(21) Appl. No.: 15/705,845

(22) Filed: Sep. 15, 2017

(51) Int. Cl. C02F 3/10; C02F 1/72; C02F 3/00; B01D 53/85; C02F 3/34

(52) U.S. Cl. CPC C02F 3/10; C02F 1/725; C02F 2101/101; B01D 53/85; C02F 3/345; C02F 3/006

(57) ABSTRACT

Processes for treatment of spent alkaline stream is disclosed. The process includes passing a spent alkaline stream comprising one or more sulfide compounds and one or more organic compounds to a sulfide oxidation reactor for partial oxidation of the one or more sulfide compounds to provide an effluent stream comprising one or more thiosulfate compounds. The effluent stream is passed to a biological treatment unit to oxidize the one or more thiosulfate compounds to one or more sulfate compounds and biodegrade the one or more organic compounds to carbon dioxide and water to provide a treated alkaline stream.

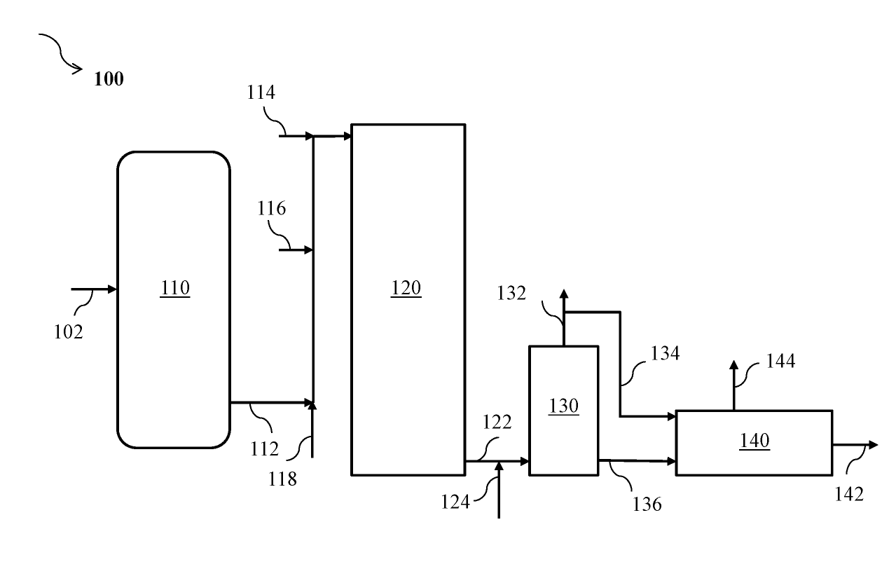

### FIELD

The subject matter relates to processes for treatment of spent alkaline waste streams, and more particularly relates to the integrated process including a sulfide partial oxidation stage with a biological treatment stage for treatment of spent alkaline waste streams.

### BACKGROUND

Due to the presence of sulfur compounds in crude oil, refined products like gasoline, LPG and diesel fuel contain sulfur compounds such as mercaptans, sulfides and others. These sulfur compounds must be removed from the hydrocarbon products for odor control and to avoid to corrosion problems. A common post-refining sulfur-removal method is caustic washing in which the hydrocarbon streams are contacted with concentrated caustic solutions. The caustic soda reacts with hydrogen sulfide to form sodium sulfide and with mercaptans to form sodium mercaptides. The caustic stream loaded with the above compounds is generally called spent caustic.

Spent caustic management as well as effluent treating and disposal are areas of growing interest. Spent caustic disposal costs such as waste hauling are expected to continue to increase. Unfortunately, the excessive pH, biological oxygen demand (BOD) and chemical oxygen demand (COD) of sulfidic caustic often prohibit direct re-use in process and easy disposal.

Typically, a partial oxidation process is used for treatment of spent caustic waste streams. The partial oxidation process converts sulfides present in the spent caustic to thiosulfate but does not oxidize organics that may be present in the spent caustic such as phenols. The thiosulfate present in the effluent from the partial oxidation process still contributes to Biological Oxygen Demand (BOD) and is corrosive to piping and metal surfaces and thus has resulted in limited acceptance of this solution.

Another process commercially used for treatment of spent caustic is wet air oxidation which is a high temperature and pressure process and hence capital intensive.

Therefore, there is a need for improved processes and apparatuses for treating spent caustic waste which provides for efficient removal of the sulfides and organics present in the treated spent caustic waste streams. There is a need for a process and an apparatus which is more economical as compared the currently available alternatives. Other desirable features and characteristics of the present subject matter will become apparent from the subsequent detailed description of the subject matter and the claims, taken in conjunction with the accompanying drawing and this background of the subject matter.

### SUMMARY

Various embodiments of a new processes for the treatment of spent alkaline waste streams are provided. The process is an integrated 2-stage process for treatment of spent alkaline waste streams involving the combination of sulfide partial oxidation stage with a biological treatment stage.

In accordance with an exemplary embodiment, a process is provided for process for treatment of a spent alkaline stream comprising passing the spent alkaline stream comprising one or more sulfide compounds and one or more organic compounds to a sulfide oxidation reactor for partial oxidation of the one or more sulfide compounds to provide an effluent stream comprising one or more thiosulfate compounds. The effluent stream is passed to a biological treatment unit to oxidize the one or more thiosulfate compounds to one or more sulfate compounds and biodegrade the one or more organic compounds to carbon dioxide and water to provide a treated alkaline stream.

In accordance with another exemplary embodiment, a process is provided for treatment of a spent alkaline stream comprising passing the spent alkaline stream comprising one or more sulfide compounds and one or more organic compounds to a sulfide oxidation reactor operating at a temperature of about 75° C. to about 120° C. and a pressure of about 400 kPa (g) to about 1000 kPa (g) for partial oxidation of the one or more sulfide compounds to provide an effluent stream comprising one or more thiosulfate compounds and comprises no more than about 100 wppm of sulfides. The effluent stream is mixed with a liquid stream to reduce salt concentration to less than about 3 wt % total salinity. The effluent stream is passed to a biological treatment unit to oxidize the one or more thiosulfate compounds to one or more sulfate compounds and biodegrade the one or more organic compounds to the carbon dioxide and water to provide a treated alkaline stream.

These and other features, aspects, and advantages of the present disclosure are further explained by the following detailed description, drawing and appended claims.

### BRIEF DESCRIPTION OF THE DRAWING

The various embodiments will hereinafter be described in conjunction with the FIGURE, wherein like numerals denote like elements.

The FIGURE illustrates a process and apparatus for treatment of a spent alkaline stream according to an embodiment of the present disclosure.

Skilled artisans will appreciate that elements in the FIGURE are illustrated for simplicity and clarity and have not necessarily been drawn to scale. For example, the dimensions of some of the elements in the FIGURE may be exaggerated relative to other elements to help to improve understanding of various embodiments of the present disclosure. Also, common but well-understood elements that are useful or necessary in a commercially feasible embodiment may not be depicted in order to facilitate a less obstructed view of these various embodiments of the present disclosure.

### DETAILED DESCRIPTION

Various embodiments herein relate to processes for the treatment of spent alkaline stream. As used herein, the term “stream” can include various hydrocarbon molecules, such as straight-chain, branched, or cyclic alkanes, alkenes, alkadienes, and alkynes, and optionally other substances, such as gases, e.g., hydrogen, or impurities, such as heavy metals, and sulfur and nitrogen compounds. The stream can also include aromatic and non-aromatic hydrocarbons. Moreover, the hydrocarbon molecules may be abbreviated C₁, C₂, C₃ . . . Cₙ where “n” represents the number of carbon atoms in the one or more hydrocarbon molecules. Furthermore, a superscript “+” or “−” may be used with an abbreviated one or more hydrocarbons notation, e.g., C₃₊ or C₃₋, which is inclusive of the abbreviated one or more hydrocarbons. As an example, the abbreviation “C₃₊” means one or more hydrocarbon molecules of three carbon atoms and/or more. In addition, the term “stream” may be applicable to other fluids, such as aqueous and non-aqueous solutions of alkaline or basic compounds, such as sodium hydroxide.

As used herein, the term “unit” can refer to an area including one or more equipment items and/or one or more zones. Equipment items can include one or more reactors or reactor vessels, heaters, exchangers, pipes, pumps, compressors, and controllers. Additionally, an equipment item, such as a reactor, dryer, or vessel, can further include one or more zones or sub-zones.

As used herein, the term “alkali” can mean any substance or material that in solution, typically a water solution, has a pH value greater than about 7.0, and exemplary alkali can include sodium hydroxide, potassium hydroxide, or ammonia. Such an alkali in solution may be referred to as an alkaline solution or an alkaline. The term “caustic” refers to alkaline solutions such as potassium hydroxide and sodium hydroxide.

As used herein, the term “phase” may mean a liquid, a gas, or a suspension including a liquid and/or a gas, such as a foam, aerosol, or fog. A phase may include solid particles. Generally, a fluid can include one or more gas, liquid, and/or suspension phases.

As used herein, the term “parts per million” may be abbreviated herein as “ppm” and unless otherwise specified it refers to “weight ppm”, abbreviated herein as “wppm”.

As used herein, the term “weight percent” may be abbreviated “wt. %” and unless otherwise specified the notation “%” refers to “wt. %””.

As used herein, the term “thiol” or “mercaptan” can include a mercaptan and a salt thereof, such as a mercaptide. A thiol can be of the formula RSH or a salt of the formula RS−M+ where R is a hydrocarbon group, such as an alkyl or aryl group, that is saturated or unsaturated and optionally substituted, and M is a metal, such as sodium or potassium.

As used herein, the term “substantially” can mean an amount of at least generally about 80%, or about 90%, and or about 99%, by mole, of a compound or class of compounds in a stream.

As depicted, process flow lines in the FIGURE can be referred to, interchangeably, as, e.g., lines, pipes, branches, distributors, streams, effluents, feeds, products, portions, catalysts, withdrawals, recycles, suctions, discharges, and caustics.

Arriving now to the FIGURE, an apparatus 100 for treatment of a spent alkaline stream may include a surge drum 110, a sulfide oxidation reactor 120, a sulfide oxidation vent tank 130 and a biological treatment unit 140. A surge drum is often used in such processes, however, it is optional and the instant process can be practiced without the surge drum. Accordingly, while the following discussion will feature the surge drum, it is understood, as noted above, that the present process is in no way limited to such an embodiment.

In accordance with an exemplary embodiment as shown in FIGURE, a spent alkaline stream in line 102 is obtained and sent to surge drum 110 for storage. Generally, the spent alkaline stream in line 102 may be obtained from a hydrocarbon purification process. Such a hydrocarbon purification process can include contacting a hydrocarbon stream with an alkaline stream to facilitate the removal of sulfur compounds. Afterwards, the spent alkaline stream contaminated with one or more contaminants is removed from the process. It is desired to remove at least specific contaminants prior to disposal or recycle. The one or more contaminants present in the spent alkaline stream may include one or more sulfide compounds, one or more organic compounds and other contaminants including mercaptans. In an embodiment, the spent alkaline stream may include from about 10 to about 170 g/L of sodium sulfide and about 100-10,000 wppm of mercaptans. Two or more alkaline streams from various sources may be combined to provide the spent alkaline stream. The spent alkaline stream in line 102 may contain about 1 to about 30, about 1 to about 10, or about 1 to about 6%, by weight, of an alkaline material. In some embodiments, one or more additional streams (not shown) can be added to the spent alkaline stream 102. For example, a stripped sour water steam, an oxygen-containing (typically air) stream, and/or a carbon dioxide containing stream may be added. In various embodiments, the alkaline stream may be a caustic stream and accordingly spent alkaline stream may be interchangeably referred to as the spent caustic stream. The spent caustic stream may comprise sodium hydroxide, potassium hydroxide and mixtures thereof.

As shown in the FIGURE, the spent alkaline stream stored in the surge drum 110 may be passed to the sulfide oxidation reactor 120 via a line 112. Further, an oxygen-containing stream (typically air) in line 114, a carbon dioxide stream in line 116 and a steam stream in line 118 may be passed to the sulfide oxidation reactor 120. One or more sulfide compounds are partially oxidized in the sulfide oxidation reactor 120 through a sulfide oxidation process to provide an effluent stream in line 122. In the sulfide oxidation reactor 120, the sulfide compounds present in alkaline stream are partially oxidized to thiosulfates and the mercaptan compounds are oxidized to the disulfides salts. The one or more organic compounds remain unconverted. Accordingly, the sulfide oxidation stage can be used to convert the spent caustic stream from, for example, from the hydrocarbon purification process, to an effluent with low pH and reduced BOD/COD characteristics.

The sulfide oxidation stage may be catalytic or non-catalytic process. In one embodiment, the sulfide oxidation reactor 120 employs an oxidation catalyst. The oxidation catalyst can be any known oxidation catalyst, such as a sulfonated metal phthalocyanine, as described in US Publication No. 2014/0202963. Other suitable examples are described in, for example, U.S. Pat. No. 7,326,333. One or more of the oxidation catalysts, the oxygen-containing streams, the carbon dioxide streams, the steam stream and the alkaline stream can be combined before or after entering the sulfide oxidation reactor 120.

The sulfide oxidation reactor 120 can operate at a temperature of about 75° C. to about 120° C., or from about 85° C. to about 105° C., and a pressure of about 440 kPa to about 1,830 kPa, or from about 400 kPa (g) to about 1000 kPa (g). In some embodiments, there are two or more sulfide oxidation reactors (now shown). The effluent from the one or more reactors can be passed through a cooler (not shown). Further details, specifics and variations regarding the sulfur oxidation process are described in U.S. Pat. Nos. 5,470,486 and 5,207,927, incorporated herein by reference in their entireties.

The effluent stream in line 122 is withdrawn from the sulfide oxidation reactor 120. The effluent stream in line 122 may include alkali, the one or more thiosulfate compounds, the one or more organic compounds and gases/vapors. If necessary, the effluent stream in line 122 may be mixed with a liquid stream in line 124 to reduce salt concentration to less than about 3 wt. % total salinity before passing the effluent stream to the biological treatment unit 140. In an embodiment, the effluent stream may comprise a salt concentration of more than about 1 wt. % to about 3 wt. % total salinity. The amount of liquid stream mixed to the effluent stream in line 124 may be controlled based on a target salinity set at less than about 3 wt. %. In an aspect, the amount of liquid stream mixed may be adjusted using a control system. The control system may include a processor and any suitable structure for interacting with one or more sensors and controlling one or more actuators. The control system could, for example, represent a multivariable controller, such as a Robust Multivariable Predictive Control Technology (RMPCT) controller or other type of controller implementing model predictive control (MPC) or other advanced predictive control (APC). As a particular example, each controller could represent a computing device running a real-time operating system. In an aspect, the control system may include one or more sensors, wherein the one or more sensors measure the target salinity in the effluent stream. In an embodiment, the amount of the liquid stream being mixed with the effluent stream may be controlled based on an inlet temperature of the biological treatment unit 140 using the control system.

In some embodiments, various functions described herein may be implemented or supported by a computer program that is formed from computer readable program code and that is embodied in a computer readable medium. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), Blu-ray or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device

The effluent stream may be passed to the biological treatment unit 140. The effluent stream being passed to biological treatment unit 140 comprises no more than about 100 wppm, or about 50 wppm, or about 10 wppm of sulfides. Further, the pH of the effluent being passed to the biological treatment reactor is no more than about 8. In accordance with an exemplary embodiment as shown in the FIGURE, the effluent stream in line 122 may be passed to the sulfide oxidation vent tank 130. An exhaust air stream in line 132 comprising excess air is withdrawn from the sulfide oxidation vent tank 130. The exhaust air stream may contain hydrogen sulfide gas and mercaptans. A portion of the exhaust air stream in line 134 may be passed to the biological treatment unit 140 to oxidize the one or more mercaptan compounds present in the exhaust air stream to disulfide compounds. The portion of the exhaust air stream may be passed to the biological treatment unit after a post-treatment step (not shown) such as thermal treatment or oxidation.

A treated effluent stream is withdrawn in line 136 from the sulfide oxidation vent tank 130. The treated effluent stream may be passed to the biological treatment unit 140 to oxidize the one or more thiosulfate compounds to one or more sulfate compounds and biodegrade the one or more organic compounds, including phenol, to carbon dioxide and water. In an embodiment, the biological treatment unit 140 may include a fixed film bioreactor containing an effective quantity of bacteria immobilized on a packing material within the bioreactor. In operation, air is circulated to the bioreactor to provide oxygen to the bacteria. Some sulfides are volatilized into the air and the air-sulfide mixture is removed in line 144 from the bioreactor. Further, a water stream is passed through the bioreactor to remove soluble sulfates. Further details, specifics and variations regarding the biological treatment unit and associated process are described in U.S. Pat. Nos. 4,983,299, 5,217,616, 5,543,052, 5,580,770, 6,395,522, 6,498,281, 7,378,022 and 7,582,474, incorporated herein by reference in their entireties. A treated alkaline stream in line 142 is withdrawn from the biological treatment unit. The treated alkaline stream comprises less than 0.2 mg/L sulfides.

Applicants have found that the integrated process having a partial sulfide oxidation stage followed by a biological treatment stage as described provides synergistic advantages in that deficiencies of one system are negated by the other system, and the integrated process is economically advantageous as compared to current alternatives. The partial sulfide oxidation stage only requires partial oxidation of the sulfides to thiosulfates and hence is a low temperature, low pressure system which contributes to savings in capital expenditure and operating costs. Also, organic compounds which are not converted in the partial oxidation stage can be handled in the biological treatment stage.

A biological treatment unit treating a feed high in sulfides, consumes large quantities of oxygen which adds to cost. However, the instant process provides uses a partial oxidation stage to provide a low sulfide feed to the biological treatment stage resulting in reduced oxygen consumption in the biological treatment stage, and thus cost savings.

Spent alkaline streams are typically highly basic (pH-14) and should be adjusted to a pH of about 8 before the spent alkaline stream can be further processed, used or recycled. Sending a highly basic stream directly to the biological treatment unit results in significant H₂S generation, which is undesirable. Further, the H₂S is converted in the bioreactor to sulfur and then to sulfur sludge which fouls the reactor. Using the 2-stage process outlined in present disclosure results in less H₂S generation as the sulfides are converted to thiosulfates in the partial oxidation stage which remains in the solution. A lower volume of H₂S in the bioreactor will result in significantly reduced H₂S emissions. Furthermore, incorporating a partial oxidation stage to convert sulfides to thiosulfates, operates to eliminate or minimize sulfur sludge formation in the bioreactor and reduce fouling of the bioreactor. Accordingly, applicants have found the combination of the partial sulfide oxidation stage with a biological treatment stage provides synergistic advantages and is economically advantageous as compared to current alternatives.

### Specific Embodiments

While the following is described in conjunction with specific embodiments, it will be understood that this description is intended to illustrate and not limit the scope of the preceding description and the appended claims.

A first embodiment of the invention is a process for treatment of a spent alkaline stream, comprising passing the spent alkaline stream comprising one or more sulfide compounds and one or more organic compounds to a sulfide oxidation reactor for partial oxidation of the one or more sulfide compounds to provide an effluent stream comprising one or more thiosulfate compounds; and passing the effluent stream to a biological treatment unit to oxidize the one or more thiosulfate compounds to one or more sulfate compounds and biodegrade the one or more organic compounds to carbon dioxide and water to provide a treated alkaline stream. An embodiment of the invention is one, any or all of prior embodiments in this paragraph up through the first embodiment in this paragraph, wherein the spent alkaline stream comprises about 10 to about 170 g/L of sodium sulfide and about 100-10,000 wppm of mercaptans. An embodiment of the invention is one, any or all of prior embodiments in this paragraph up through the first embodiment in this paragraph, wherein the sulfide oxidation reactor operates at a temperature of about 75° C. to about 120° C. An embodiment of the invention is one, any or all of prior embodiments in this paragraph up through the first embodiment in this paragraph, wherein the sulfide oxidation reactor operates at a pressure of about 400 kPa(g) to about 1000 kPa(g). An embodiment of the invention is one, any or all of prior embodiments in this paragraph up through the first embodiment in this paragraph further comprising adding an oxygen-containing gas, a carbon dioxide stream and a steam stream to the sulfide oxidation reactor for partial oxidation of the one or more sulfide compounds. An embodiment of the invention is one, any or all of prior embodiments in this paragraph up through the first embodiment in this paragraph, wherein the effluent being passed to biological treatment unit comprises no more than about 100 wppm of sulfides. An embodiment of the invention is one, any or all of prior embodiments in this paragraph up through the first embodiment in this paragraph, wherein the pH of the effluent being passed to the biological treatment unit is no more than about 8. An embodiment of the invention is one, any or all of prior embodiments in this paragraph up through the first embodiment in this paragraph further comprising mixing the effluent stream with a liquid stream to reduce salt concentration to less than about 3 wt % total salinity before passing the effluent to the biological treatment unit. An embodiment of the invention is one, any or all of prior embodiments in this paragraph up through the first embodiment in this paragraph further comprising controlling an amount of the liquid stream being mixed with the effluent based on an inlet temperature of the biological treatment unit. An embodiment of the invention is one, any or all of prior embodiments in this paragraph up through the first embodiment in this paragraph further comprising passing an exhaust air stream from the sulfide oxidation reactor to the biological treatment unit to oxidize the one or more mercaptan compounds present in the exhaust air stream to disulfide compounds. An embodiment of the invention is one, any or all of prior embodiments in this paragraph up through the first embodiment in this paragraph, wherein the biological treatment unit is a fixed film bioreactor containing an effective quantity of bacteria immobilized on a packing material within the bioreactor. An embodiment of the invention is one, any or all of prior embodiments in this paragraph up through the first embodiment in this paragraph further comprising circulating air to the bioreactor to provide oxygen to the bacteria and removing air containing sulfides that volatilized into a gas phase into the air. An embodiment of the invention is one, any or all of prior embodiments in this paragraph up through the first embodiment in this paragraph further comprising passing a water stream through the bioreactor to remove soluble sulfates. An embodiment of the invention is one, any or all of prior embodiments in this paragraph up through the first embodiment in this paragraph, wherein the treated alkaline stream comprises less than 0.2 mg/L sulfides.

A second embodiment of the invention is a process for treatment of a spent alkaline stream, comprising passing the spent alkaline stream comprising one or more sulfide compounds and one or more organic compounds to a sulfide oxidation reactor operating at a temperature of about 75° C. to about 120° C. and a pressure of about 400 kPa (g) to about 1000 kPa (g) for partial oxidation of the one or more sulfide compounds to provide an effluent stream comprising one or more thiosulfate compounds and comprises no more than about 100 wppm of sulfides; mixing the effluent stream with a liquid stream to reduce salt concentration to less than about 3 wt % total salinity; and passing the effluent stream to a biological treatment unit to oxidize the one or more thiosulfate compounds to one or more sulfate compounds and biodegrade the one or more organic compounds to the carbon dioxide and water to provide a treated alkaline stream. An embodiment of the invention is one, any or all of prior embodiments in this paragraph up through the second embodiment in this paragraph, wherein the spent alkaline stream comprises about 10 to about 170 g/L of sodium sulfide and about 100-10,000 wppm of mercaptans. An embodiment of the invention is one, any or all of prior embodiments in this paragraph up through the second embodiment in this paragraph, further comprising adding an oxygen-containing gas, a carbon dioxide stream and a steam stream to the sulfide oxidation reactor for partial oxidation of the one or more sulfide compounds. An embodiment of the invention is one, any or all of prior embodiments in this paragraph up through the second embodiment in this paragraph, wherein the biological treatment unit is a fixed film bioreactor containing an effective quantity of bacteria immobilized on a packing material within the bioreactor. An embodiment of the invention is one, any or all of prior embodiments in this paragraph up through the second embodiment in this paragraph further comprising mixing the effluent stream with a liquid stream to reduce salt concentration to less than about 3 wt % total salinity before passing the effluent to the biological treatment unit. An embodiment of the invention is one, any or all of prior embodiments in this paragraph up through the second embodiment in this paragraph further comprising controlling the amount of the liquid stream being mixed with the effluent based on an inlet temperature of the biological treatment unit.

Without further elaboration, it is believed that using the preceding description that one skilled in the art can utilize the present invention to its fullest extent and easily ascertain the essential characteristics of this invention, without departing from the spirit and scope thereof, to make various changes and modifications of the invention and to adapt it to various usages and conditions. The preceding preferred specific embodiments are, therefore, to be construed as merely illustrative, and not limiting the remainder of the disclosure in any way whatsoever, and that it is intended to cover various modifications and equivalent arrangements included within the scope of the appended claims.

In the foregoing, all temperatures are set forth in degrees Celsius and, all parts and percentages are by weight, unless otherwise indicated.

1. A process for treatment of a spent alkaline stream, comprising:
passing the spent alkaline stream comprising one or more sulfide compounds and one or more organic compounds to a sulfide oxidation reactor for partial oxidation of the one or more sulfide compounds to provide an effluent stream comprising one or more thiosulfate compounds; and
passing the effluent stream to a biological treatment unit to oxidize the one or more thiosulfate compounds to one or more sulfate compounds and biodegrade the one or more organic compounds to carbon dioxide and water to provide a treated alkaline stream.

2. The process of claim 1, wherein the spent alkaline stream comprises about 10 to about 170 g/L of sodium sulfide and about 100-10,000 wppm of mercaptans.

3. The process of claim 1, wherein the sulfide oxidation reactor operates at a temperature of about 75° C. to about 120° C.

4. The process of claim 1, wherein the sulfide oxidation reactor operates at a pressure of about 400 kPa(g) to about 1000 kPa(g).

5. The process of claim 1 further comprising adding an oxygen-containing gas, a carbon dioxide stream and a steam stream to the sulfide oxidation reactor for partial oxidation of the one or more sulfide compounds.

6. The process of claim 1, wherein the effluent being passed to biological treatment unit comprises no more than about 100 wppm of sulfides.

7. The process of claim 1, wherein the pH of the effluent being passed to the biological treatment unit is no more than about 8.

8. The process of claim 1 further comprising mixing the effluent stream with a liquid stream to reduce salt concentration to less than about 3 wt % total salinity before passing the effluent to the biological treatment unit.

9. The process of claim 1 further comprising controlling an amount of the liquid stream being mixed with the effluent based on an inlet temperature of the biological treatment unit.

10. The process of claim 1 further comprising passing an exhaust air stream from the sulfide oxidation reactor to the biological treatment unit to oxidize the one or more mercaptan compounds present in the exhaust air stream to disulfide compounds.

11. The process of claim 1, wherein the biological treatment unit is a fixed film bioreactor containing an effective quantity of bacteria immobilized on a packing material within the bioreactor.

12. The process of claim 1 further comprising circulating air to said bioreactor to provide oxygen to said bacteria and removing air containing sulfides that volatilized into a gas phase into the air.

13. The process of claim 1 further comprising passing a water stream through said bioreactor to remove soluble sulfates.

14. The process of claim 1, wherein the treated alkaline stream comprises less than 0.2 mg/L sulfides.

15. A process for treatment of a spent alkaline stream, comprising:
passing the spent alkaline stream comprising one or more sulfide compounds and one or more organic compounds to a sulfide oxidation reactor operating at a temperature of about 75° C. to about 120° C. and a pressure of about 400 kPa (g) to about 1000 kPa (g) for partial oxidation of the one or more sulfide compounds to provide an effluent stream comprising one or more thiosulfate compounds and comprises no more than about 100 wppm of sulfides;
mixing the effluent stream with a liquid stream to reduce salt concentration to less than about 3 wt % total salinity; and
passing the effluent stream to a biological treatment unit to oxidize the one or more thiosulfate compounds to one or more sulfate compounds and biodegrade the one or more organic compounds to the carbon dioxide and water to provide a treated alkaline stream.

16. The process of claim 15, wherein the spent alkaline stream comprises about 10 to about 170 g/L of sodium sulfide and about 100-10,000 wppm of mercaptans.

17. The process of claim 15, further comprising adding an oxygen-containing gas, a carbon dioxide stream and a steam stream to the sulfide oxidation reactor for partial oxidation of the one or more sulfide compounds.

18. The process of claim 15, wherein the biological treatment unit is a fixed film bioreactor containing an effective quantity of bacteria immobilized on a packing material within said bioreactor.

19. The process of claim 15 further comprising mixing the effluent stream with a liquid stream to reduce salt concentration to less than about 3 wt % total salinity before passing the effluent to the biological treatment unit.

20. The process of claim 15 further comprising controlling the amount of the liquid stream being mixed with the effluent based on an inlet temperature of the biological treatment unit.
